(19) United States
(12) Patent Application Publication
(10) Pub. No.: US 2023/0233293 A1
(43) Pub. Date: Jul. 27, 2023

(54) ORTHODONTIC APPLIANCES

(71) Applicant: Braces On Demand, Inc., Hicksville, NY (US)

(72) Inventors: Colin James Corey, Carlsbad, CA (US); Ammar Ahmed Syed, Unionville (CA); Thomas Patrick Shannon, Byron Center, MI (US)

(21) Appl. No.: 18/100,415

(22) Filed: Jan. 23, 2023

Related U.S. Application Data
(60) Provisional application No. 63/302,285, filed on Jan. 24, 2022.

(51) Int. Cl. A61C 7/14; A61C 7/16

(52) U.S. Cl. CPC A61C 7/143; A61C 7/16

(57) ABSTRACT

In some embodiments, apparatuses and methods are provided herein useful to orthodontics. In some embodiments, an orthodontic appliance comprises a body, wherein the body comprises a bonding surface, wherein the bonding surface is configured to be bonded to a surface of a patient’s tooth, a facial surface including an insertion opening, and a compound archwire slot, wherein the compound archwire slot includes an insertion portion and a retention portion, wherein the insertion portion extends into the body from the insertion opening, wherein the retention portion is formed within the body, and wherein the retention portion is angled relative to the insertion opening.

### TECHNICAL FIELD

This invention relates generally to orthodontics and, more specifically, orthodontic appliances

### BACKGROUND

Orthodontic clinicians seek to correct malocclusions by use of many different devices, such as braces, retainers, pallet expanders, positioners, etc. Braces, one of the most commonly used devices, include a number of orthodontic appliances such as brackets and archwires. The brackets are affixed to a patient’s teeth and the archwire passes through slots in the brackets designed to receive the archwire. The brackets can use active ligation or self-ligation to retain the archwire in the archwire slot. In the case of active ligation, a ligature is used to retain the archwire within the archwire slot. Typically, the ligature is wrapped about tie wings of the bracket to secure the device to the bracket. In the case of self-ligating brackets, the brackets include a feature (e.g., a door) that encloses the archwire slot to retain the archwire within the archwire slot. This feature is typically movable from a first position (e.g., an open position) to a second position (e.g., a closed position). When in the open position, the archwire can be inserted into the archwire slot. When in the closed position, the feature retains the archwire within the archwire slot. While self-ligating brackets remove the need for ligatures, self-ligating brackets are complex in that they are made of multiple parts and/or have moving parts. This complexity makes self-ligating brackets more difficult, and expensive, to manufacture and introduces failure points to the brackets. Accordingly, a need exists for orthodontic appliances with improved ligation mechanisms.

### BRIEF DESCRIPTION OF THE DRAWINGS

Disclosed herein are embodiments of systems, apparatuses, and methods pertaining to orthodontic appliances. This description includes drawings, wherein:

FIG. 1A is a top view of an orthodontic appliance 100, according to some embodiments;

FIG. 1B is a first perspective view of the orthodontic appliance 100, according to some embodiments;

FIG. 1C is an elevational view of the orthodontic appliance 100, according to some embodiments.

FIG. 1D is a second perspective view of the orthodontic appliance 100, according to some embodiments;

FIG. 2A is a top view of an orthodontic appliance 200, according to some embodiments;

FIG. 2B is a first perspective view of the orthodontic appliance 200, according to some embodiments;

FIG. 2C is an elevational view of the orthodontic appliance 200, according to some embodiments;

FIG. 2D is a second perspective view of the orthodontic appliance 200, according to some embodiments;

FIG. 3A is a top view of an orthodontic appliance 300, according to some embodiments;

FIG. 3B is a perspective view of the orthodontic appliance 300, according to some embodiments;

FIG. 3C is an elevational view of the orthodontic appliance 300, according to some embodiments;

FIG. 4A is a top view of an orthodontic appliance 400, according to some embodiments;

FIG. 4B is a perspective view of the orthodontic appliance 400, according to some embodiments;

FIG. 4C is an elevational view of the orthodontic appliance 400, according to some embodiments;

FIG. 5A is a top view of an orthodontic kit 500 including a carrier 502, orthodontic appliances 504, and support structures 506, according to some embodiments;

FIG. 5B is a front view of the orthodontic kit 500, according to some embodiments;

FIG. 6 is a flow chart including example operations for additively manufacturing orthodontic appliances, according to some embodiments;

FIG. 7 is a block diagram of a system 700 for additively manufacturing orthodontic appliances, according to some embodiments; and

FIG. 8 is a block diagram of a system 800 that may be used for implementing any of the components, circuits, circuitry, systems, functionality, apparatuses, processes, or devices of the system 700 of FIG. 7, and/or other above or below mentioned systems or devices, or parts of such circuits, circuitry, functionality, systems, apparatuses, processes, or devices, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

Generally speaking, pursuant to various embodiments, systems, apparatuses, and methods are provided herein useful to orthodontics. In some embodiments, an orthodontic appliance comprises a body, wherein the body comprises a bonding surface, wherein the bonding surface is configured to be bonded to a surface of a patient’s tooth, a facial surface including an insertion opening, and a compound archwire slot, wherein the compound archwire slot includes an insertion portion and a retention portion, wherein the insertion portion extends into the body from the insertion opening, wherein the retention portion is formed within the body, and wherein the retention portion is angled relative to the insertion opening.

As previously discussed, braces typically include orthodontic appliances (e.g., brackets, buccal tubes, Class II correctors, Class III correctors, etc.) and an archwire. The archwire passes through archwire slots of the orthodontic appliances to exert a force on the orthodontic appliances and thus a patient’s teeth. To ensure that the archwire is properly retained in the archwire slot and exerting a force on the patient’s teeth, the archwire must be secured within the archwire slot. Typically, archwires are retained in archwire slots via active ligation or self-ligation. While self-ligating orthodontic appliances can eliminate the need for ligatures, self-ligating orthodontic appliances are more complex than orthodontic appliances that rely on ligatures to retain the archwire. Self-ligating orthodontic appliances are more complex, as self-ligating orthodontic appliances include multiple parts and/or moving parts. For example, a self-ligating orthodontic appliance may include a spring-loaded door. The spring biases the door in a closed position. In use, a clinician opens the door against the bias of the spring to insert the archwire into the archwire slot. Once the archwire is inserted into the archwire slot, the spring biases the door closed and the door encloses the archwire thus retaining the archwire. Because self-ligating orthodontic appliances are more complex than actively ligated orthodontic appliances, they are more difficult and expensive to manufacture. Additionally, because self-ligating orthodontic appliances include multiple parts and/or moving parts, self-ligating brackets are more likely to fail than orthodontic appliances without multiple parts and/or moving parts.

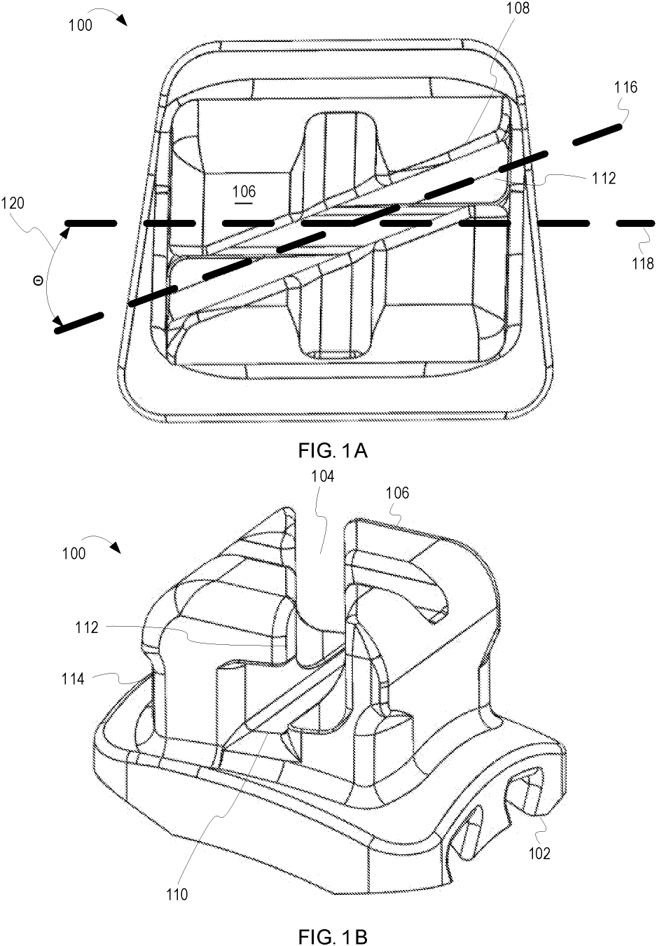

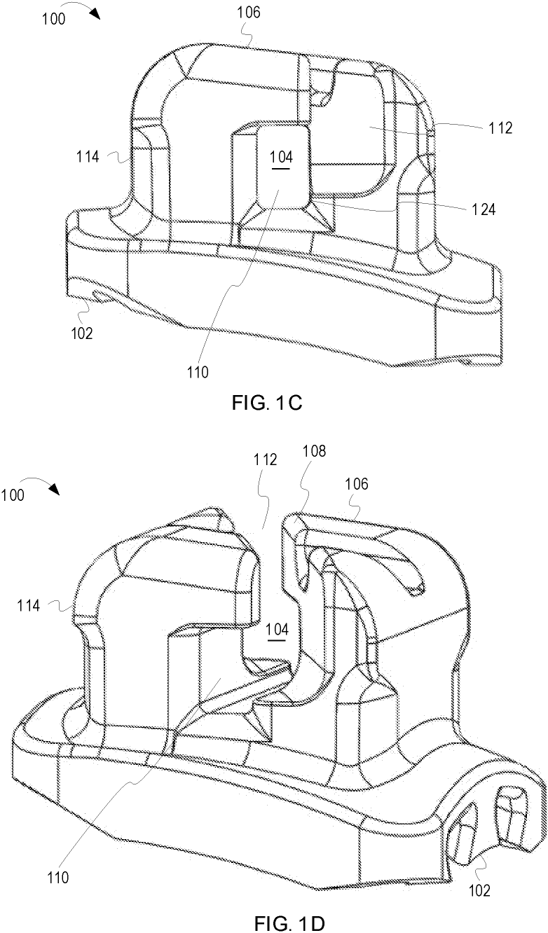

Described herein are systems, methods, and apparatuses that seek to overcome, if not eliminate, the drawbacks of self-ligating orthodontic appliances. In one embodiment, an orthodontic appliance includes a compound archwire slot. The compound archwire slot includes an insertion portion and a retention portion. The insertion portion allows for insertion of an archwire. The insertion portion and the retention portion are not aligned, as in a typical orthodontic appliance. For example, the insertion portion and the retention portion can be angled relative to each other, the insertion portion can be offset relative to the retention portion, or the insertion portion can be nonlinear. Because the insertion portion and the retention portion are not aligned, the retention portion can retain the archwire within the compound archwire slot without the need for ligatures, multiple parts, and/or movable parts. The discussion of FIGS. 1A - 1D describes a first embodiment of such an orthodontic appliance in which the retention portion is angled relative to an insertion opening

FIGS. 1A - 1D depict an orthodontic appliance 100 including a compound archwire slot 104, according to some embodiments. The orthodontic appliance 100 generally includes a body 114, a bonding surface 102, and a facial surface 106. The bonding surface 102 is configured to be bonded to a surface of a patient’s tooth (e.g., a facial or lingual surface of a patient’s tooth). For example, the orthodontic appliance 100 can be bonded to a patient’s tooth via an adhesive. The facial surface 106 is generally opposite the bonding surface 102. The orthodontic appliance 100 includes an archwire slot 104. The archwire slot 104 is a compound archwire slot. The archwire slot 104 is a compound archwire slot in that it includes multiple portions (e.g., separate areas that are communicatively coupled such that an archwire can pass from one portion of the archwire slot 104 to another portion of the archwire slot 104). In the example depicted in FIGS. 1A - 1D, the archwire slot 104 includes an insertion portion 112 and a retention portion 110. Each of the insertion portion 112 and the retention portion 110 can be shaped to receive and/or retain an archwire. For example, the insertion portion 112 and the retention portion 210 can have polygonal cross sections (e.g., triangular, rectangular, hexagonal, etc.) and/or rounded cross sections (e.g., circular, oblong, etc.). Additionally, the insertion portion 112 and the retention portion 110 can take any suitable size.

The insertion potion 112 extends into the body 102 of the orthodontic appliance 100 from an insertion opening 108. The insertion opening 108 is an opening in the facial surface 106. In use, an archwire is inserted into the archwire slot 104 via the insertion opening 108. The retention portion 110 is communicatively coupled to the insertion portion 112. That is, the retention portion 110 is at least partially open to the insertion portion 112 such that the archwire can be inserted into the insertion portion 112 via the insertion opening 108 and pass into the retention portion 110. The retention portion 110 is configured to retain the archwire. In one embodiment, the retention portion 110 can be at least partially enclosed to retain the archwire. For example, the upper surface (i.e., on the facial side) of the retention portion 110 can be partially enclosed by the body 114 retaining the archwire in a facial direction. The body 114 can extend over the retention portion 110 to any suitable degree. For example, the body 114 can extend over the retention portion in a distance that is approximately as wide as the archwire, a percentage of the width of the archwire (e.g., 5% to 100%), a percentage of the width of the retention portion 110, etc. Additionally, in some embodiments, the retention portion 110 can extend into the body 114 to a greater depth than the insertion portion 112. Such a geometry of the retention portion 110 forms a lip 124. The lip 124 can aid in preventing the archwire from exiting the retention portion 110 into the insertion portion 112 once the archwire is secured in the retention portion 110.

In the embodiment depicted in FIGS. 1A - 1D, the retention portion 110 is angled relative to the insertion opening 108 and/or the insertion portion 112. As depicted in FIG. 1A, a first line 116 depicts the path of the insertion opening 108 across the body 114 of the orthodontic appliance 100 relative to the facial surface 106 and a second line 118 depicts the path of the retention portion 110 across the body 114 of the orthodontic appliance 100 relative to the facial surface 106. An angle theta (Θ), indicated by an arrow 120, reflects the degree to which the path of the insertion opening 108 is angled relative to the retention portion 110. The angle theta can be of any suitable magnitude (i.e., the angle between the retention portion 110 and the insertion portion 108 can be of any suitable magnitude). In one form, the angle theta is an acute angle. For example, the angle theta can be between 5 degrees and 85 degrees, 20 degrees and 70 degrees, 15 degrees and 25 degrees, etc.

In use, a clinician deforms or otherwise manipulates the archwire such that it can be inserted into the insertion portion 112 of the archwire slot 104 via the insertion opening 108. As the archwire passes through the insertion portion 112 it begins to return to its undeformed or unmanipulated shape (e.g., due to the elasticity of the archwire and/or physical input by the clinician), ultimately seating in the retention portion 110. In some embodiments, due in part to the angle between the insertion opening 108 and the retention portion 110, the archwire will remain seated in the retention portion 110 of the archwire slot 104 during the daily activities of the patient. That is, the angled geometry of the insertion slot 108 relative to the retention portion 110 aids in preventing the archwire from being unintentionally or inadvertently removed from the archwire slot 104 during the patient’s daily activities without the need for additional ligation mechanisms. For example, as depicted in FIGS. 1A - 1D, the orthodontic appliance 100 does not feature tie wings. Because tie wings are not necessary, in some embodiments, the orthodontic appliance 100 depicted in FIGS. 1A - 1D can be used with both an archwire and an aligner (e.g., in parallel and/or in series). For example, the orthodontic appliance 100 can be a hybrid attachment in which the facial surface 106 has a nonnegative draft with respect to a direction normal to a facial surface of the patient’s tooth, as described in U.S. Pat. Appl. No. 17/498,363 titled ORTHODONTIC DEVICES AND METHODS OF USE filed Oct. 11, 2021 and incorporated by reference herein in its entirety.

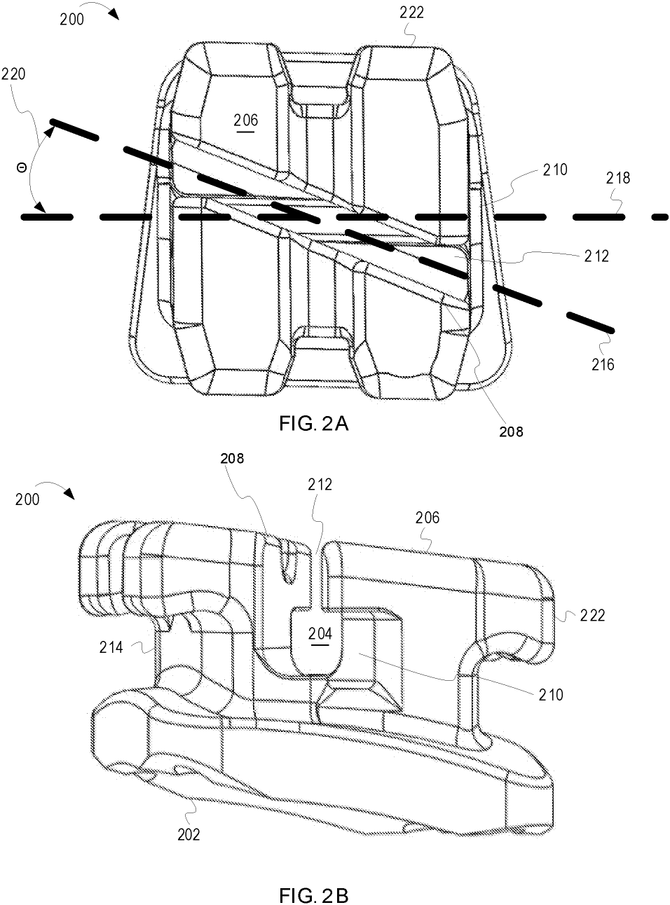

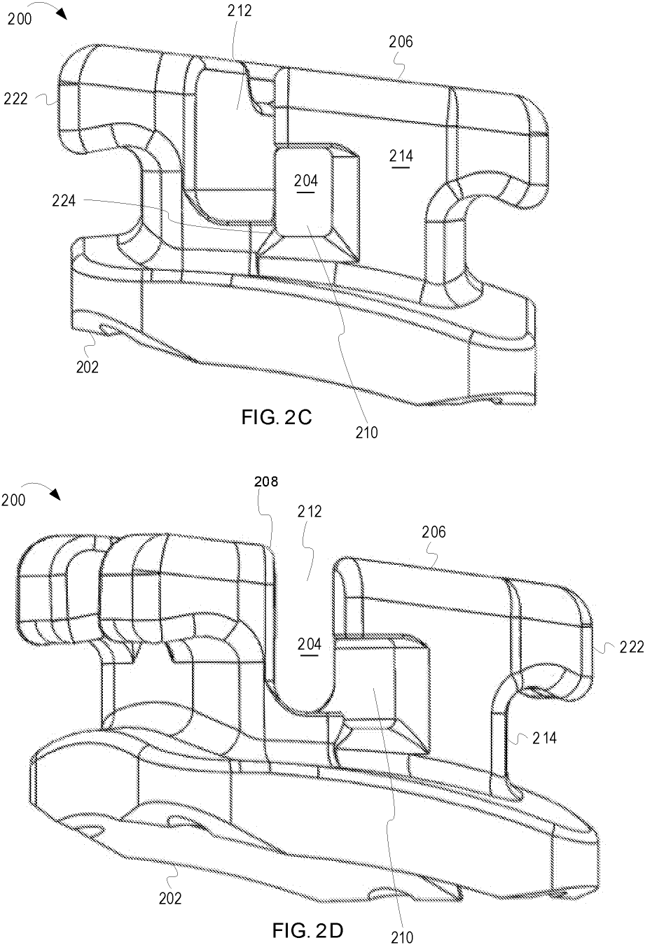

While the discussion of FIGS. 1A - 1D describe an orthodontic appliance including a compound archwire slot without tie wings, the discussion of FIGS. 2A - 2D describes an orthodontic appliance including a compound archwire slot and tie wings.

FIGS. 2A - 2D depict an orthodontic appliance 200 including a compound archwire slot 204, according to some embodiments. The orthodontic appliance 200 generally includes a body 214, a bonding surface 202, and a facial surface 206. The bonding surface 202 is configured to be bonded to a surface of a patient’s tooth (e.g., a facial or lingual surface of a patient’s tooth). For example, the orthodontic appliance 200 can be bonded to a patient’s tooth via an adhesive. The facial surface 206 is generally opposite the bonding surface 202. The orthodontic appliance 200 includes an archwire slot 204. The archwire slot 204 is a compound archwire slot. The archwire slot 204 is a compound archwire slot in that it includes multiple portions (e.g., separate areas that are communicatively coupled such that an archwire can pass from one portion of the archwire slot 204 to another portion of the archwire slot 204). In the example depicted in FIGS. 2A - 2D, the archwire slot 204 includes an insertion portion 212 and a retention portion 210. Each of the insertion portion 212 and the retention portion 210 can be shaped to receive and/or retain an archwire. For example, the insertion portion 212 and the retention portion 210 can have polygonal cross sections (e.g., triangular, rectangular, hexagonal, etc.) and/or rounded cross sections (e.g., circular, oblong, etc.). Additionally, the insertion portion 212 and the retention portion 210 can take any suitable size.

The insertion potion 212 extends into the body 202 of the orthodontic appliance 200 from an insertion opening 208. The insertion opening 208 is an opening in the facial surface 206. In use, an archwire is inserted into the archwire slot 204 via the insertion opening 208. The retention portion 210 is communicatively coupled to the insertion portion 212. That is, the retention portion 210 is at least partially open to the insertion portion 212 such that the archwire can be inserted into the insertion portion 212 via the insertion opening 208 and pass into the retention portion 210. The retention portion 210 is configured to retain the archwire. In one embodiment, the retention portion 210 can be at least partially enclosed to retain the archwire. For example, the upper surface (i.e., on the facial side) of the retention portion 210 can be partially enclosed by the body 214 retaining the archwire in a facial direction. The body 214 can extend over the retention portion 210 to any suitable degree. For example, the body 214 can extend over the retention portion 210 in a distance that is approximately as wide as the archwire, a percentage of the width of the archwire (e.g., 5% to 100%), a percentage of a width of the retention portion 210, etc. Additionally, in some embodiments, the retention portion 210 can extend into the body 214 to a greater depth than the insertion portion 212. Such a geometry of the retention portion 210 forms a lip. The lip can aid in preventing the archwire from exiting the retention portion 210 into the insertion portion 212 once the archwire is retained in the retention portion 210 of the archwire slot 204.

In the embodiment depicted in FIGS. 2A - 2D, the retention portion 210 is angled relative to the insertion opening 208 and/or the insertion portion 212. As depicted in FIG. 2A, a first line 216 depicts the path of the insertion opening 208 across the body 214 of the orthodontic appliance 200 relative to the facial surface 206 and a second line 218 depicts the path of the retention portion 210 across the body 214 of the orthodontic appliance 200 relative to the facial surface 206. An angle theta (Θ), indicated by an arrow 220, reflects that degree to which the path of the insertion opening 208 is angled relative to the retention portion 210. The angle theta can be of any suitable magnitude (i.e., the angle between the retention portion 210 and the insertion portion 208 can be of any suitable magnitude). In one form, the angle theta is an acute angle. For example, the angle theta can be between 5 degrees and 85 degrees, 20 degrees and 70 degrees, 15 degrees and 25 degrees, etc.

In use, a clinician deforms or otherwise manipulates the archwire such that it can be inserted into the insertion portion 212 of the archwire slot 204 via the insertion opening 208. As the archwire passes through the insertion portion 212 it begins to return to its undeformed or unmanipulated shape (e.g., due to the elasticity of the archwire and/or physical input by the clinician), ultimately seating in the retention portion 210. In some embodiments, due in part to the angle between the insertion opening 208 and the retention portion 210, the archwire will remain seated in the retention portion 210 of the archwire slot 204 during the daily activities of the patient. That is, the angled geometry of the insertion slot 208 relative to the retention portion 210 aids in preventing the archwire from being unintentionally removed from the archwire slot 204 during the patient’s daily activities without the need for additional ligation mechanisms. Although no additional ligation mechanisms are necessary to retain the archwire in the archwire slot 204, in some embodiments, the orthodontic appliance 200 can include tie wings 222. The tie wings 222 extend from the body 214 of the orthodontic appliance 200 and can be used for anchoring ligatures on the orthodontic appliance 200. In some embodiments with such an orthodontic device 200, a clinician can use ligatures in addition to the orthodontic appliance’s self-ligating mechanism (i.e., the compound archwire slot 204) to further secure, or differently secure, the archwire. It should be noted that, in some embodiments, the orthodontic appliances described herein (e.g., those in any of FIGS. 1-4) can include other devices, such as hooks.

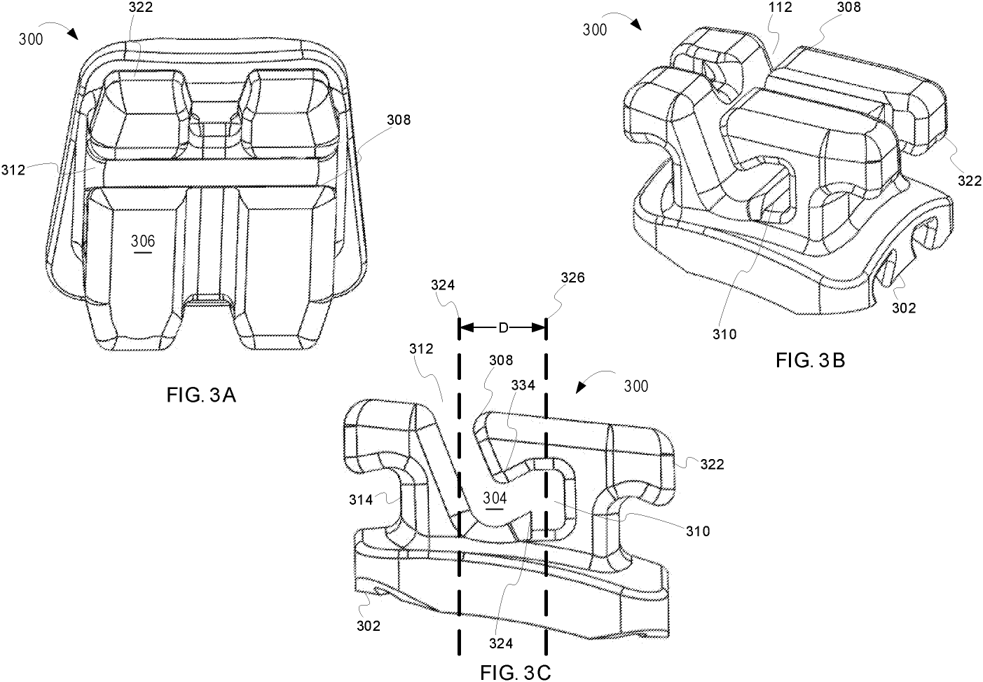

While the discussion of FIGS. 1A - 1D and 2A - 2D describes orthodontic appliances including compound archwire slots in which a retention portion of the archwire slot is angled relative to an insertion opening, the discussion of FIGS. 3A - 3C describes an orthodontic appliance including a compound archwire slot in which a retention portion is offset relative to an insertion opening.

FIGS. 3A - 3C depict an orthodontic appliance 300 including a compound archwire slot 304, according to some embodiments. The orthodontic appliance 300 generally includes a body 314, a bonding surface 302, and a facial surface 306. The bonding surface 302 is configured to be bonded to a surface of a patient’s tooth (e.g., a facial or lingual surface of a patient’s tooth). For example, the orthodontic appliance 300 can be bonded to the patient’s tooth via an adhesive. The facial surface 306 is located opposite the bonding surface 302. The facial surface 306 includes an insertion opening 308. An archwire slot 304 extends from the insertion opening 308. In the example depicted in FIGS. 3A - 3C, the archwire slot 304 is a compound archwire slot. The archwire slot 304 is a compound archwire slot in that it includes multiple portions (e.g., separate areas that are communicatively coupled such that an archwire can pass from one portion of the archwire slot 304 to another portion of the archwire slot 304). In the example depicted in FIGS. 3A - 3C, the archwire slot 304 includes an insertion portion 312 and a retention portion 310. Each of the insertion portion 312 and the retention portion 310 can be shaped to receive and/or retain an archwire. For example, the insertion portion 312 and the retention portion 310 can have polygonal cross sections (e.g., triangular, rectangular, hexagonal, etc.) and/or rounded cross sections (e.g., circular, oblong, etc.). Additionally, the insertion portion 312 and the retention portion 310 can take any suitable size.

In the example depicted in FIGS. 3A - 3C, the retention portion 310 is offset relative to the insertion opening 308. As best shown in FIG. 3C, a first line 324 indicates a center of the insertion opening 308 and a second line 326 indicates a center of the retention portion 310. The retention portion 310 is offset from the insertion opening 308 by a distance D. The distance of the offset can be of any suitable magnitude. For example, the distance of the offset can be a percentage of a width of the retention portion, an absolute distance, etc. In one embodiment, the retention portion 310 is offset relative to the insertion opening 308 by at least forty percent of the width of the retention portion 310. The offset between the retention portion 310 and the insertion opening 308 can aid in retaining the archwire within the retention portion 310 of the archwire slot 304. Though the example provided in FIGS. 3A - 3C depicts the retention portion 310 being offset from the insertion opening 308 in a gingival direction, such is not required. For example, in some embodiments, the retention portion 310 is offset from the insertion opening 308 in an occlusal direction. Accordingly, an opening between the retention portion 310 and the insertion portion 312 can be on the gingival or occlusal side of the body 314.

In some embodiments, the archwire slot 304 includes additional features to aid in retaining the archwire within the retention portion 310 of the archwire slot 304. For example, as depicted in FIGS. 3A - 3C, the retention portion 310 extends into the body 314 to a greater depth than the insertion portion 312. This variance in the depth of the insertion portion 312 and the retention portion 310 forms a lip 324. The lip 324 can aid in preventing the archwire from moving from the retention portion 310 to the insertion portion 312 once the archwire has been seated in the retention portion 310. Additionally, or alternatively, in some embodiments, a nub 334 can protrude into a portion of the archwire slot 304. For example, as depicted in FIGS. 3A -3C, the nub 334 extend from the body into the insertion portion 310 of the archwire slot 304. The nub 334 can aid in preventing the archwire from moving from the retention portion 310 to the insertion portion 312 once the archwire has been seated in the retention portion 310. Though depicted as including tie wings 322, it should be noted that in some embodiments, the orthodontic appliance depicted in FIG. 3 need not include tie wings 322.

In one embodiment, as depicted in FIGS. 3A - 3C, the insertion portion 312 and the retention portion are not parallel with one another in a direction from the base 302 to the facial surface 306. That is, while the retention portion 310 is generally parallel to the second line 326, the insertion portion 310 is not parallel to the first line 324. Alternatively, the insertion portion 312 and the retention portion 310 can be parallel to one another in a direction from the base 302 to the facial surface 306. Regardless of the orientation of the orientations of the retention portion 310 and the insertion portion 312, one or both of the retention portion 310 and the insertion portion 312 can be at least partially curved. For example, as depicted in FIGS. 3A -3C, the insertion portion 312 is partially curved between the insertion opening 308 and the retention portion 310. Such a curvature may aid in a clinician in properly and easily seating the archwire in the retention portion 310.

In some examples, as depicted in FIGS. 3A - 3C, the insertion opening 308 is generally parallel to the retention portion 310. That is, the insertion opening 308 and the retention portion 310 traverse the body 314 of the orthodontic appliance 300 in generally parallel routes. Though the insertion opening 308 and retention portion 310 are generally parallel in the example provided in FIGS. 3A - 3C, such is not required. For example, in some embodiment, the insertion opening 308 can be angled relative to the retention portion. That is, in some embodiments, the insertion opening 308 can be offset from, and at an angle relative to, the retention portion 310.

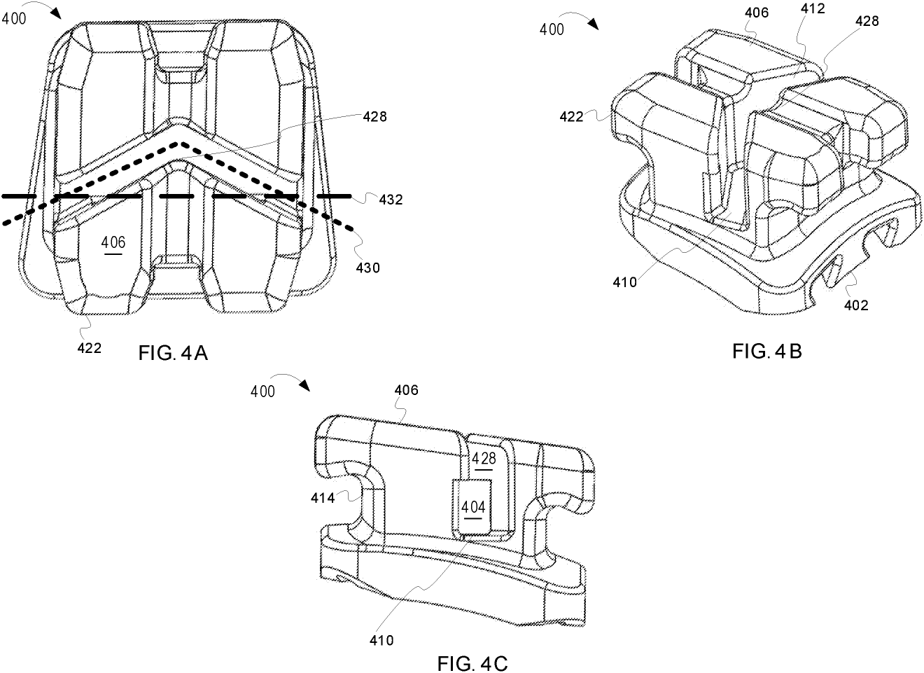

While the discussion of FIGS. 3A - 3C describes an orthodontic appliance including a compound archwire slot in which a retention portion is offset relative to an insertion opening, the discussion of FIGS. 4A - 4C describes an orthodontic appliance including a compound archwire slot in which an insertion opening is nonlinear.

FIGS. 4A - 4C depict an orthodontic appliance 400 including a compound archwire slot 404, according to some embodiments. The orthodontic appliance generally comprises a body 414, a bonding surface 402, and facial surface 406. The bonding surface 402 is configured to be bonded to a surface of a patient’s tooth (e.g., a facial or lingual surface of a patient’s tooth). For example, the orthodontic appliance 400 can be bonded to the patient’s tooth via an adhesive. The facial surface 406 is located opposite the bonding surface 402. The facial surface 406 includes an insertion opening 408. An archwire slot 404 extends from the insertion opening 408. In the example depicted in FIGS. 4A - 4C, the archwire slot 404 is a compound archwire slot. The archwire slot 404 is a compound archwire slot in that it includes multiple portions (e.g., separate areas that are communicatively coupled such that an archwire can pass from one portion of the archwire slot 404 to another portion of the archwire slot 404). In the example depicted in FIGS. 4A - 4C, the archwire slot 404 includes an insertion portion 412 and a retention portion 410. Each of the insertion portion 412 and the retention portion 410 can be shaped to receive and/or retain an archwire. For example, the insertion portion 412 and the retention portion 410 can have polygonal cross sections (e.g., triangular, rectangular, hexagonal, etc.) and/or rounded cross sections (e.g., circular, oblong, etc.). Additionally, the insertion portion 412 and the retention portion 310 can take any suitable size.

In the example depicted in FIGS. 4A - 4C, the insertion opening 408 is nonlinear. That is, while the retention portion 410 extends generally linearly across the body 414 of the orthodontic appliance 400 in a mesial-distal direction, the insertion opening 408 is not linear. Instead, the insertion opening 408 includes a protrusion 428 defining a peak of the insertion opening 408. The protrusion 428 is an extension of the body near adjacent to the facial surface 406. The protrusion 428 extends over, and at least partially covers, the retention portion 410. The protrusion 428 can extend over and/or cover any suitable portion of the retention portion 410. For example, the protrusion 428 can extend to cover between 5% and 100% of the retention portion 410. Further, the protrusion 428 can take any suitable shape.

Because the protrusion is defined by the nonlinearity of the insertion opening 408, the shape of the insertion opening 408 can be adjusted to result in any protrusion shape desired. For example, as depicted in FIGS. 4A - 4C, the insertion opening 408 is formed by two nonparallel linear segments. Because the insertion opening 408 is formed by two nonparallel linear segments, the protrusion 428 is triangular in shape in the example depicted in FIGS. 4A -4C. Thought the example depicted in FIGS. 4A - 4C includes an insertion opening 408 defined by two nonparallel linear segments, such is not required. For example, the insertion opening 408 can be defined by greater than two linear segments (e.g., three, four, five, etc.), one or more of which may be nonparallel with respect to others of the linear segments. Additionally, or alternatively, in some embodiments, some or all of the insertion opening 408 may be nonlinear such that it is curved. For example, the insertion opening 408 can be defined by linear segments and/or curved segments. In embodiments in which at least a portion of the insertion opening 408 is curved, the protrusion can feature a curved, or partially curved, shape.

In use, a clinician deforms or otherwise manipulates the archwire to insert the archwire into the insertion portion 412 via the insertion opening 408. Once seated within the retention portion 410, the archwire takes it original (or desired) shape.

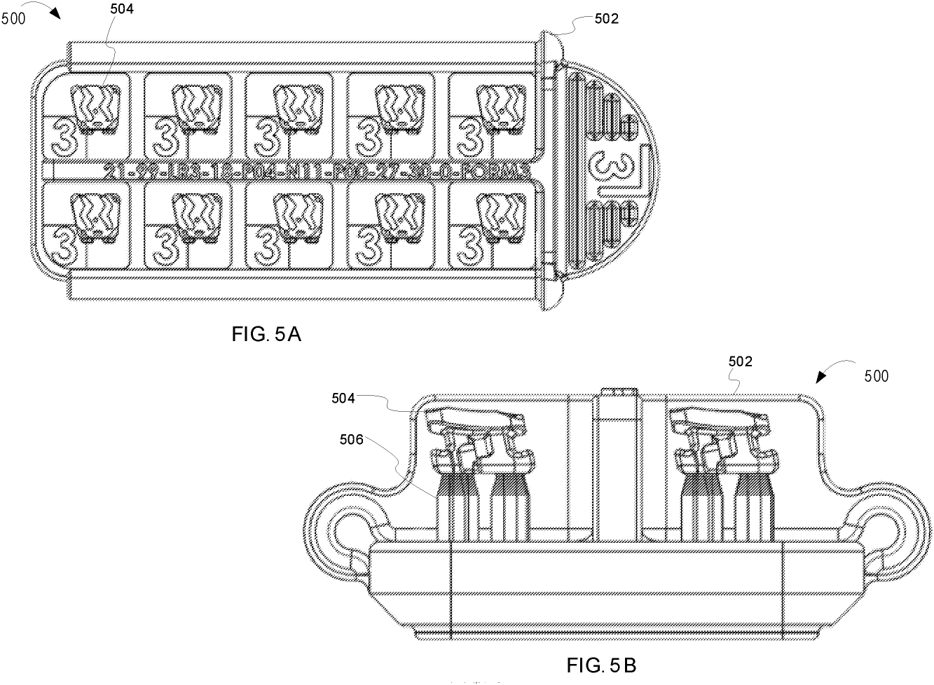

FIGS. 5A and 5B depict an orthodontic kit 500 including a carrier 502, orthodontic appliances 504, and support structures 506, according to some embodiments. The carrier 502 is configured to house the orthodontic appliances 504. The support structures 506 connect the orthodontic appliances 504 to the carrier 502. The support structures 506 comprise groups of support structures 506. Each group of support structures 506 connects one of the orthodontic appliances 504 to the carrier 502.

In one embodiment, the orthodontic kit 500 is additively manufactured, such as by way of the techniques described in U.S. Pat. Application No. 16/875,618 titled SYSTEMS AND METHODS FOR MANUFACTURE OF ORTHODONTIC APPLIANCES filed on May 15, 2020 and incorporated by reference herein in its entirety. For example, the orthodontic kit 500 can be additively manufactured by a 3D printing process. In such embodiments, the orthodontic kit 500 is additively manufactured as a single unit (e.g., structure). Accordingly, the carrier 502, orthodontic appliances 504, and support structures 506 are additively manufactured as a single unit. Further, the orthodontic kit 500 can be defined by a computer data file (e.g., a CAD file, such as an .stl file). The computer data file includes all of the data necessary to additively manufacture the orthodontic kit 500. That is, the computer data file includes all of the data necessary to additively manufacture the carrier 502, the orthodontic appliances 504, and the support structures 506. In some embodiments, the orthodontic kit 500 can be additively manufactured without additively manufacturing anything in addition to the orthodontic kit 500. For example, the orthodontic kit 500 can be additively manufactured without the need for additional supports, bases, etc.

The support structures 506 provide a structure upon which the orthodontic appliances 504 can be additively manufactured. In some embodiments, the support structures 506 are specific to the orthodontic appliances 504. For example, different types of orthodontic appliances 504 may require different types of support structures 506 for the orthodontic appliances 504 to be additively manufactured correctly. In such embodiments, the groups of support structures 506 may have different types and the different types of groups of support structures 506 may be specific to different types of orthodontic appliances 504. The type of the group of support structures 506 can be based on the dimensions of the orthodontic appliances 504, features of the orthodontic appliances 504 (e.g., presence or lack of hooks), parameters of the orthodontic appliances 504 (e.g., a tip angle of a bracket), etc. For example, a bracket with a hook can be oriented parallel to the carrier 502 and include five support structures 506, a bracket without any hooks can be oriented parallel to the carrier 502 and include four support structures 506, and a molar tube can be oriented normal to the carrier 502 and include three support structures 506. Further, the shape, placement, geometry, etc. of the support structures 506 can be tailored to the device associated with the support structures 506. Because the data necessary to additively manufacture the orthodontic kit 500 includes the data necessary to additively manufacture the support structures 506, the support structures can be designed as desired based on the orthodontic appliances 504. For example, the support structures 506 can be designed such than no internal supports are necessary for the orthodontic appliances 504. Additionally, the support structures 506 can be designed such that the orthodontic appliances 504 are easily removable from the support structures 506.

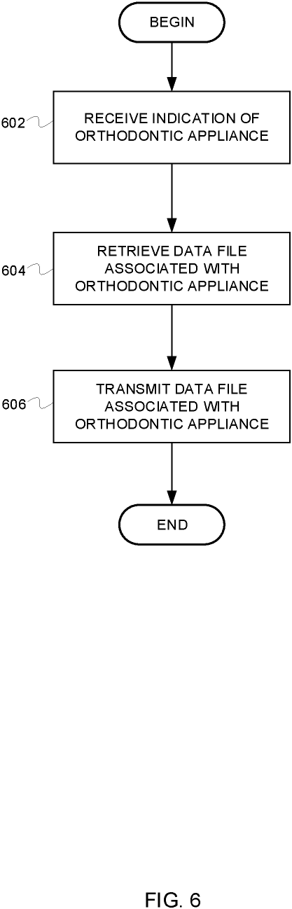

While the discussion of FIGS. 1-5 describe orthodontic appliances, the discussion of FIG. 6 provides additional detail regarding the manufacture of orthodontic appliances.

FIG. 6 is a flow chart including example operations for additively manufacturing orthodontic appliances, according to some embodiments. The flow beings at block 602.

At block 602, an indication of an orthodontic appliance is received. For example, an indication of the orthodontic appliance can be received by a control circuit. The flow continues at block 604.

At block 604, a data file is retrieved. For example, the control circuit can retrieve the data file. The data file is associated with the orthodontic appliance. In one embodiment, the data file includes the data necessary to additively manufacture the orthodontic appliance. In some embodiments, the data file is one of a plurality of data files stored in a database. Each of the plurality of the data files is associated with a different orthodontic appliance. The flow continues at block 606.

At block 606, the data file is transmitted. For example, the control circuit can transmit the data file to a manufacturing device. The manufacturing device is configured to manufacture the orthodontic appliance based on the data file.

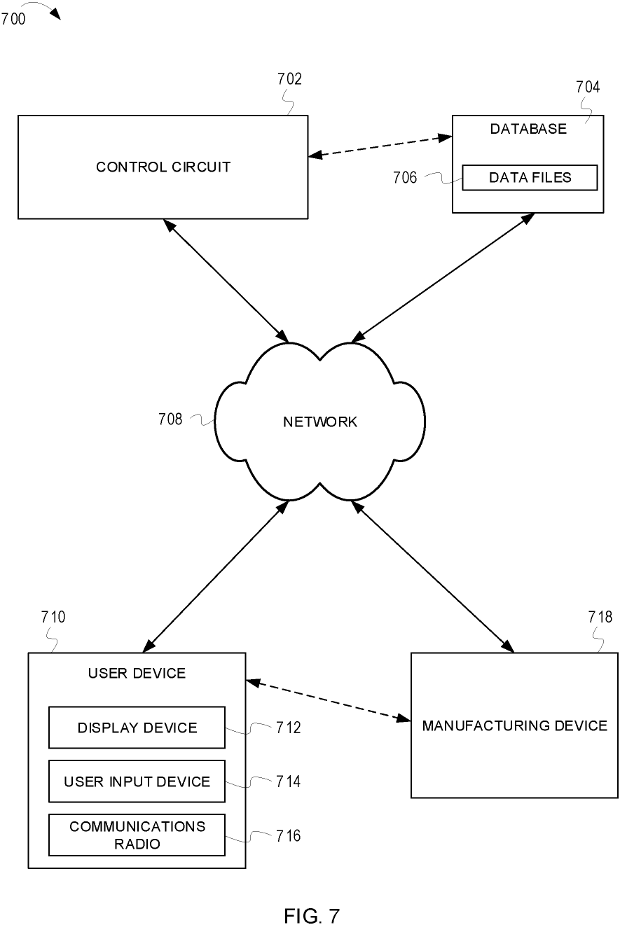

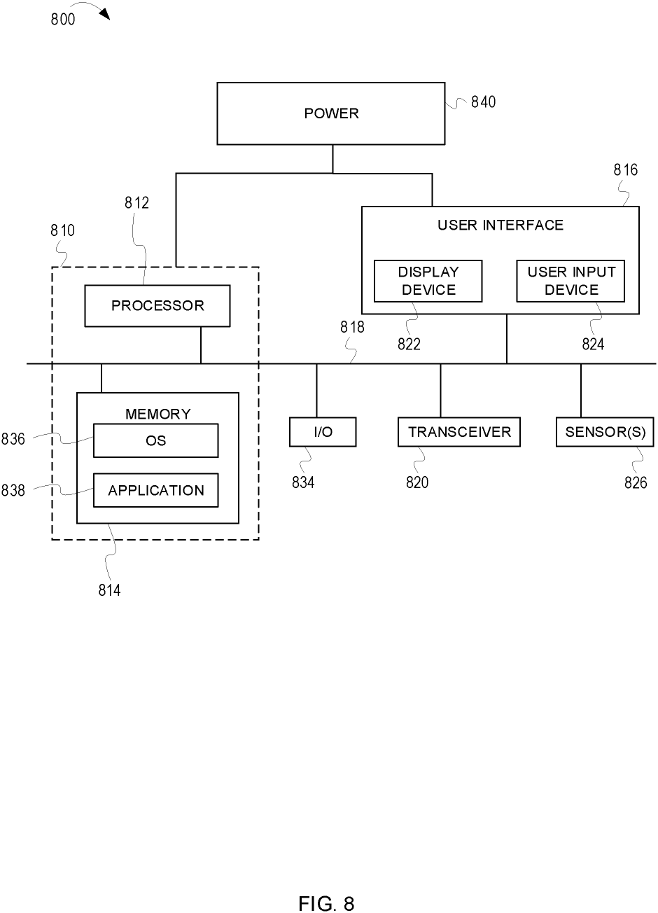

While the discussion of FIG. 6 describes example operations for manufacturing an orthodontic appliance, the discussion of FIGS. 7 and 8 provide additional detail regarding system for manufacturing orthodontic devices.

FIG. 7 is a block diagram of a system 700 for additively manufacturing orthodontic devices, according to some embodiments. The system 700 includes a control circuit 702, a database 704, a user device 710, and a manufacturing device 718. One or more of the control circuit 702, the database 704, the user device 710, and the manufacturing device 718 are communicatively coupled via a network 708. The network 708 can include a local area network (LAN) and/or wide area network (WAN), such as the internet. Accordingly, the network 708 can include wired and/or wireless links.

The user device 710 can be any suitable type of computing device (e.g., a desktop or laptop computer, smartphone, tablet, etc.). The user device 710 includes a display device 712. The display device 712 is configured to present a catalogue to a user. The catalogue includes orthodontic appliances that the user can obtain via the system 700. For example, the catalogue can include all orthodontic devices that the user can purchase and/or manufacture via the manufacturing device 718. The user interacts with the catalogue via a user input device 714. The user can interact with the catalogue by navigating the catalogue, making selections from the catalogue, modifying orthodontic appliances included in the catalogue, etc. Accordingly, the user input device 714 can be of any suitable type, such as a mouse, keyboard, trackpad, touchscreen, etc. The user device 710 also includes a communications radio 716. The communications radio 716 transmits and receives information for the user device 710. For example, in the case of a smartphone, the communications radio 716 can be a cellular radio operating in accordance with the 4G LTE standard. Once a user has made a selection of an orthodontic appliance, the user device 710, via the communications radio 716 and the network 708, transmits an indication of the selection to the control circuit 702.

The control circuit 702 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 702 is configured (for example, by using corresponding programming as will be well understood by those skilled in the art) to carry out one or more of the steps, actions, and/or functions described herein.

By one optional approach the control circuit 702 operably couples to a memory. The memory may be integral to the control circuit 702 or can be physically discrete (in whole or in part) from the control circuit 702 as desired. This memory can also be local with respect to the control circuit 702 (where, for example, both share a common circuit board, chassis, power supply, and/or housing) or can be partially or wholly remote with respect to the control circuit 702 (where, for example, the memory is physically located in another facility, metropolitan area, or even country as compared to the control circuit 702).

This memory can serve, for example, to non-transitorily store the computer instructions that, when executed by the control circuit 702, cause the control circuit 702 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit may be remote from the user device 710 and/or the manufacturing device 718. For example, the user device 710 and the manufacturing device 718 may be located in a clinician’s office (e.g., the user’s office) whereas the control circuit 702, and possibly the database 704, are cloud-based. The control circuit 702 generally operates to retrieve data files 706 based on the user’s selection of orthodontic appliances. The control circuit 702 retrieves the data files 706 from the database 704. The database 704 is configured to store the data files 706. The data files 706 are associated with orthodontic appliances. The data files 706 are CAD files from which the orthodontic devices can be manufactured. The database 704 stores a data file for each of the orthodontic appliances included in the catalogue. In one embodiment, the database 704 stores a data file for all possible permutations of each orthodontic appliance (e.g., every possible modification and/or combination or modifications for each orthodontic appliance). The control circuit 702 receives the indication of the orthodontic appliance and retrieves a data file based on the indication of the orthodontic appliance.

It should be noted that the indication of the orthodontic appliance may include more than one orthodontic appliance. For example, the indication of the orthodontic appliance can include multiple orthodontic appliances, such as full set of brackets for a patient. Accordingly, the data file can be a file including instructions and/or specifications for multiple orthodontic appliances. For example, the data file may include multiple data files and/or multiple specifications for a number of brackets.

In some embodiments, the control circuit 702 generates a data file associated with an orthodontic device. The orthodontic device includes a bonding tray, orthodontic appliances, and support structures. The support structures secure the orthodontic appliances to the bonding tray. The data file associated with the orthodontic device includes the data necessary to manufacture the orthodontic device. The control circuit 702 generates the data file associated with the orthodontic device based on the orthodontic appliances selected from the catalogue and data associated with the patient’s mouth. The data associated with the patient’s mouth can include measurements of the patient’s dentition, scans of the patient’s mouth, models of the patient’s mouth, a prescription associated with the patient’s mouth, etc. In some embodiments, the control circuit 702 can make selections for the orthodontic device based on the selected orthodontic appliances and/or the data associated with the patient’s mouth. For example, the control circuit can select (or otherwise generate) a planar or curved bonding tray, the curvature of the bonding tray, the dimensions of the bonding tray, the orientations of the orthodontic appliances with respect to one another and/or the bonding tray, the locations of the orthodontic appliances with respect to one another and/or the bonding tray, markers associated with the orthodontic device and/or orthodontic appliances, etc.

After generating the data file associated with the orthodontic device, the control circuit 702 transmits the data file associated with the orthodontic device. In some embodiments, the control circuit 702 encrypts or otherwise protects the data file associated with the orthodontic device before transmission. The control circuit 702 can encrypt or otherwise protect the data file associated with the orthodontic device before transmission to prevent those other than the user from accessing the data file. Additionally, in some embodiments, the control circuit 702 can encrypt or otherwise protect the data file associated with the orthodontic device to control the user’s access to the data file associated with the orthodontic device. For example, in some embodiments, the system is set up such that users pay on a per manufacture or per print basis. That is, the user does not purchase, and may not later have access to, the data files associated with the orthodontic appliances and/or the data file associated with the orthodontic device. Rather, the user purchases access to print or otherwise manufacture an orthodontic device based on the data file associated with the orthodontic device once (or another specified number of times).

Dependent upon the embodiment, the control circuit 702 transmits the data file associated with the orthodontic device to the user device 710, the manufacturing device 718, or a third-party device (e.g., a laboratory capable of manufacturing the orthodontic appliance for the user). To whom, or to what, device the data file associated with the orthodontic device is transmitted may also aid in achieving access control. For example, in one embodiment, the control circuit 702 transmits the data file associated with the orthodontic device directly to the manufacturing device 718. Because the data file associated with the orthodontic device is not transmitted to the user device 710, the data file associated with the orthodontic device may not be easily accessible by the user device 710. Further, if an entity that controls the control circuit 702 controls the manufacturing device 718, access to files received by the manufacturing device 718 may be further limited. In some embodiments, the control circuit 702 transmits the data file associated with the orthodontic device to the user device 710. In such embodiments, the user device 710 transmits, via the communications radio (e.g., over a universal serial bus (USB) connection, wireless connection based on the 802.11 standard, etc.), the data file associated with the orthodontic device to the manufacturing device 718.

The manufacturing device 718 additively manufacturers the orthodontic device based on the data file. The manufacturing device 718 can be of any suitable type, such as a 3D printer. The manufacturing device 718 can be local to, or remote from, one or more of the control circuit 702 and the user device 710. For example, in one embodiment, the user device 710 and the manufacturing device 718 are located in the user’s office (i.e., the user device 810 and the manufacturing device 718 are local to one another). Alternatively, the manufacturing device 718 may be located in a laboratory or some other facility that manufactures orthodontic appliances for the user.

FIG. 8 is a block diagram of a system 800 that may be used for implementing any of the components, circuits, circuitry, systems, functionality, apparatuses, processes, or devices of the system 700 of FIG. 7, and/or other above or below mentioned systems or devices, or parts of such circuits, circuitry, functionality, systems, apparatuses, processes, or devices, according to some embodiments. The circuits, circuitry, systems, devices, processes, methods, techniques, functionality, services, servers, sources and the like described herein may be utilized, implemented and/or run on many different types of devices and/or systems. For example, the system 800 may be used to implement some or all of the control circuit, the database, the user device, the manufacturing device, and/or other such components, circuitry, functionality and/or devices. However, the use of the system 800 or any portion thereof is certainly not required.

By way of example, the system 800 may comprise a processor (e.g., a control circuit) 812, memory 814, and one or more communication links, paths, buses or the like 818. Some embodiments may include one or more user interfaces 816, and/or one or more internal and/or external power sources or supplies 840. The processor 812 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor 812 can be part of control circuitry and/or a control system 810, which may be implemented through one or more processors with access to one or more memory 814 that can store commands, instructions, code and the like that is implemented by the control circuit and/or processors to implement intended functionality. In some applications, the control circuit and/or memory may be distributed over a communications network (e.g., LAN, WAN, the Internet) providing distributed and/or redundant processing and functionality. Again, the system 800 may be used to implement one or more of the above or below, or parts of, components, circuits, systems, processes and the like.

In one embodiment, the memory 814 stores data and executable code, such as an operating system 836 and an application 838. The application 838 is configured to be executed by the system 800 (e.g., by the processor 812). The application 838 can be a dedicated application (e.g., an application dedicated to orthodontic appliances, orthodontic devices, the manufacture of orthodontic appliances and/or orthodontic devices, selection of orthodontic appliances, etc.) and/or a general purpose application (e.g., a web browser, a retail application etc.). Additionally, though only a single instance of the application 838 is depicted in FIG. 8, such is not required and the single instance of the application 838 is shown in an effort not to obfuscate the figures. Accordingly, the application 838 is representative of all types of applications resident on the system (e.g., software preinstalled by the manufacturer of the system, software installed by an end user, etc.). In one embodiment, the application 838 operates in concert with the operating system 836 when executed by the processor 812 to cause actions to be performed by the system 800. For example, with respect to the disclosure contained herein, execution of the application 838 by the processor 812 causes the system to perform actions consistent with the selection and/or manufacture of orthodontic appliances and/or orthodontic appliance assemblies as described herein.

The user interface 816 can allow a user to interact with the system 800 and receive information through the system. In some instances, the user interface 816 includes a display device 822 and/or one or more user input device 842, such as buttons, touch screen, track ball, keyboard, mouse, etc., which can be part of or wired or wirelessly coupled with the system 800. Typically, the system 800 further includes one or more communication interfaces, ports, transceivers 820 and the like allowing the system 800 to communicate over a communication bus, a distributed computer and/or communication network (e.g., a local area network (LAN), wide area network (WAN) such as the Internet, etc.), communication link 818, other networks or communication channels with other devices and/or other such communications or combination of two or more of such communication methods. Further the transceiver 820 can be configured for wired, wireless, optical, fiber optical cable, satellite, or other such communication configurations or combinations of two or more of such communications. Some embodiments include one or more input/output (I/O) ports 834 that allow one or more devices to couple with the system 800. The I/O ports can be substantially any relevant port or combinations of ports, such as but not limited to USB, Ethernet, or other such ports. The I/O interface 834 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 826 to provide information to the system and/or sensor information that is communicated to another component, such as the central control system, a delivery vehicle, etc. The sensors 826 can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The system 800 comprises an example of a control and/or processor-based system with processor 812. Again, the processor 812 can be implemented through one or more processors, controllers, central processing units, logic, software and the like. Further, in some implementations the processor 812 may provide multiprocessor functionality.

The memory 814, which can be accessed by the processor 812, typically includes one or more processor-readable and/or computer-readable media accessed by at least the control circuit, and can include volatile and/or nonvolatile media, such as RAM, ROM, EEPROM, flash memory and/or other memory technology. Further, the memory 814 is shown as internal to the control system 810; however, the memory 814 can be internal, external or a combination of internal and external memory. Similarly, some, or all, of the memory 814 can be internal, external or a combination of internal and external memory of the processor 812. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over a computer network. The memory 814 can store code, software, executables, scripts, data, content, lists, programming, programs, log or history data, user information, customer information, product information, and the like. While FIG. 8 illustrates the various components being coupled together via a bus, it is understood that the various components may actually be coupled to the control circuit and/or one or more other components directly.

In some embodiments, an orthodontic appliance comprises a body, wherein the body comprises a bonding surface, wherein the bonding surface is configured to be bonded to a surface of a patient’s tooth, a facial surface including an insertion opening, and a compound archwire slot, wherein the compound archwire slot includes an insertion portion and a retention portion, wherein the insertion portion extends into the body from the insertion opening, wherein the retention portion is formed within the body, and wherein the retention portion is angled relative to the insertion opening.

In some embodiments, an orthodontic appliance comprises a body, wherein the body comprises a bonding surface, wherein the bonding surface is configured to be bonded to a surface of a patient’s tooth, a facial surface including an insertion opening, and a compound archwire slot, wherein the compound archwire slot includes an insertion portion and a retention portion, wherein the insertion portion extends into the body from the insertion opening, wherein the retention portion is formed within the body, and wherein the retention portion is offset relative to the insertion opening.

In some embodiments, an orthodontic appliance comprises a body, wherein the body comprises a bonding surface, wherein the bonding surface is configured to be bonded to a surface of a patient’s tooth, an archwire slot, wherein the archwire slot is formed within the body of the orthodontic appliance, and a facial surface including a protrusion, wherein the protrusion extends from the facial surface of the orthodontic appliance and partially covers the archwire slot.

In some embodiments, an orthodontic appliance comprises a body, wherein the body comprises a bonding surface, wherein the bonding surface is configured to be bonded to a surface of a patient’s tooth, a facial surface including an insertion slot, and a compound archwire slot, wherein the compound archwire slot includes an insertion portion and a retention portion, wherein the insertion portion extends into the body from the insertion opening, wherein the retention portion is formed within the body, and wherein the insertion portion is nonlinear.

In some embodiment, a system for additively manufacturing orthodontic appliances comprises a database storing data files associated with orthodontic appliances, a user device, wherein the user device includes a display device, wherein the display device is configured to present, to a user, a catalogue, wherein the catalogue includes the orthodontic appliances, a user input device, wherein the user input device is configured to receive, from the user, a selection of one of the orthodontic appliances, and a communications radio, wherein the communications radio is configured to transmit, via a network, an indication of the one of the orthodontic appliances, a control circuit, wherein the control circuit is configured to receive, via the network from the user device, the indication of the one of the orthodontic appliances, retrieve, from the database, one of the data files associated with the one of orthodontic appliances, wherein the one of the data files associated with the plurality of the orthodontic appliances corresponds to the indication of the one of the plurality of the orthodontic appliances, generate, based on the ones of the data files associated with the plurality of orthodontic appliances and the data associated with the patient’s mouth, a data file associated with the orthodontic appliance, wherein the orthodontic appliance comprises a bonding surface, a facial surface including an insertion opening, and a compound archwire slot, wherein the compound archwire slot includes an insertion portion and a retention portion, wherein the insertion portion extends into the body from the insertion opening, wherein the retention portion is formed within the body of the orthodontic appliance, and wherein the retention portion is angled relative to the insertion opening, and wherein the data file associated with the orthodontic appliance includes data to additively manufacture the orthodontic appliance, and transmit, via the network to a manufacturing device, the data file associated with the orthodontic appliance.

In some embodiments, an apparatus and a corresponding method performed by the apparatus comprises receiving, by a control circuit from a suer device, an indication of an orthodontic appliance, retrieving, by the control circuit from a database, a data file associated with the orthodontic appliance, wherein the orthodontic appliance comprises a bonding surface, a facial surface including an insertion opening, and a compound archwire slot, wherein the compound archwire slot includes an insertion portion and a retention portion, wherein the insertion portion extends into the body from the insertion opening, wherein the retention portion is formed within the body of the orthodontic appliance, and wherein the retention portion is angled relative to the insertion opening, and transmitting, by the control circuit to a manufacturing device, the data file associated with the orthodontic appliance.

In some embodiments, an orthodontic kit comprises a carrier, wherein the carrier is configured to house a plurality of orthodontic appliances, the plurality of orthodontic appliances, wherein one orthodontic appliance of the plurality of orthodontic appliances includes a compound archwire slot having a retention portion and an insertion portion, the insertion portion extending from an insertion opening in a facial surface of the one orthodontic appliance of the plurality of orthodontic appliances, and a plurality of support structures, wherein the plurality of support structures includes groups of support structures, wherein each group of support structures connects one of the plurality of orthodontic appliances to the carrier, wherein the orthodontic kit is defined by a computer data file, wherein the computer data file includes data necessary to additively manufacture the orthodontic kit including the carrier, the plurality of orthodontic appliances, and the plurality of support structures.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. An orthodontic appliance, the orthodontic appliance comprising:
a body, wherein the body comprises:
a bonding surface, wherein the bonding surface is configured to be bonded to a surface of a patient’s tooth;
a facial surface including an insertion opening; and
a compound archwire slot, wherein the compound archwire slot includes an insertion portion and a retention portion, wherein the insertion portion extends into the body from the insertion opening, wherein the retention portion is formed within the body, and wherein the retention portion is angled relative to the insertion opening.

2. The orthodontic appliance of claim 1, wherein the insertion portion traverses the facial surface of the orthodontic appliance in a first plane, wherein the retention portion traverses the body of the orthodontic appliance in a second plane, and wherein a nonzero angle exists between the first plane and the second plane.

3. The orthodontic appliance of claim 1, wherein the insertion portion is angled relative to the retention portion in a range from 5 degrees to 85 degrees.

4. (canceled)

5. The orthodontic appliance of claim 1, wherein the body has a mesial side and a distal side, wherein the retention slot passes from the mesial side to the distal side in one or more of a plane that is substantially perpendicular to the mesial side and the distal side and in a plane that is substantially perpendicular to an occlusal-gingival plane.

6. (canceled)

7. The orthodontic appliance of claim 1, wherein the body at least partially encloses the retention portion on a facial side of the retention portion.

8. The orthodontic appliance of claim 1, wherein the retention portion extends deeper into the body than the insertion portion.

9-11. (canceled)

12. The orthodontic appliance of claim 1, wherein the retention portion is offset relative to the insertion opening.

13-14. (canceled)

15. An orthodontic appliance, the orthodontic appliance comprising:
a body, wherein the body comprises:
a bonding surface, wherein the bonding surface is configured to be bonded to a surface of a patient’s tooth;
a facial surface including an insertion opening; and
a compound archwire slot, wherein the compound archwire slot includes an insertion portion and a retention portion, wherein the insertion portion extends into the body from the insertion opening, wherein the retention portion is formed within the body, and wherein the retention portion is offset relative to the insertion opening.

16. The orthodontic appliance of claim 15, wherein the body at least partially encloses the retention portion on a facial side of the retention portion.

17. The orthodontic appliance of claim 15, wherein the retention portion extends deeper into the body than the insertion portion.

18-20. (canceled)

21. The orthodontic appliance of claim 15, wherein the retention portion is offset from the insertion opening in one of a gingival direction and an occlusal direction.

22. The orthodontic appliance of claim 15, wherein the insertion portion is at least partially curved between the insertion opening and the retention portion.

23-24. (canceled)

25. The orthodontic appliance of claim 15, wherein the retention portion is offset relative to the insertion opening by at least forty percent of a width of the retention portion.

26. The orthodontic appliance of claim 15, wherein the insertion opening and the retention portion are generally parallel.

27-33. (canceled)

34. An orthodontic appliance, the orthodontic appliance comprising:
a body, wherein the body comprises:
a bonding surface, wherein the bonding surface is configured to be bonded to a surface of a patient’s tooth;
a facial surface including an insertion opening; and
a compound archwire slot, wherein the compound archwire slot includes an insertion portion and a retention portion, wherein the insertion portion extends into the body from the insertion opening, wherein the retention portion is formed within the body, and wherein the insertion opening is nonlinear.

35. (canceled)

36. The orthodontic appliance of claim 34, wherein the facial surface includes a protrusion, and wherein the protrusion at least partially covers the retention portion.

37. The orthodontic appliance of claim 36, wherein the protrusion is defined by the nonlinearity of the insertion portion.

38. The orthodontic appliance of claim 36, wherein the protrusion is one or more of rounded and polygonal.

39. (canceled)

40. The orthodontic appliance of claim 36, wherein a width of the protrusion extends from the facial surface across at least forty percent of a width of the retention portion.

41. The orthodontic appliance of claim 34, wherein the retention portion is configured to retain an archwire within the body of the orthodontic appliance.

42-56. (canceled)
